(19) United States
(12) Patent Application Publication
(10) Pub. No.: US 2023/0270041 A1
(43) Pub. Date: Aug. 31, 2023

(54) IMPLEMENT HAVING A PNEUMATIC ACTUATOR AND ADJUSTABLE LINK, AND RELATED METHODS

(71) Applicant: AGCO Corporation, Duluth, GA (US)

(72) Inventor: Jeffrey Scott Hughes, Glen Elder, KS (US)

(21) Appl. No.: 18/005,639

(22) PCT Filed: Jun. 21, 2021
(86) PCT No.: PCT/IB2021/055446

§ 371 Date: Jan. 16, 2023

Related U.S. Application Data
(60) Provisional application No. 63/067,096, filed on Aug. 18, 2020.

(51) Int. Cl. A01C 7/20; A01C 7/08

(52) U.S. Cl. CPC A01C 7/205; A01C 7/084

(57) ABSTRACT

An implement for working an agricultural field includes a frame and a plurality of row units carried by the frame. Each row unit includes a subframe trailing the frame and connected to the frame by an upper link and a lower link, at least two different ground-engaging tools carried by the subframe, and at least one pneumatic actuator configured to change a length of the upper link or the lower link to keep the ground-engaging tools in contact with ground. A method includes pulling the implement through the agricultural field, maintaining a selected pressure in the pneumatic actuator, and maintaining the ground-engaging tools in contact with the agricultural field.

### CROSS-REFERENCE TO RELATED APPLICATION

This application claims the benefit of the filing date of U.S. Provisional Patent Application 63/067,096, “Implement Having a Pneumatic Actuator and Adjustable Link, and Related Methods,” filed Aug. 18, 2020, the entire disclosure of which is incorporated herein by reference.

### FIELD

Embodiments of the present disclosure relate to agricultural implements and methods of controlling agricultural implements. More particularly, embodiments of the present invention relate to apparatus and methods for maintaining and controlling down pressure.

### BACKGROUND

Crop yields are affected by a variety of factors, such as seed placement, soil quality, weather, irrigation, and nutrient applications. Seeds are typically planted in trenches formed by discs or other mechanisms of a planter row unit. Depth of seed placement is important because seeds planted at different depths emerge at different times, resulting in uneven crop growth. Trench depth can be affected by soil type, moisture level, row unit speed, down pressure, and operation of the opening discs. It would be beneficial to have improved methods of controlling the location of planter row units so that seeds can be more precisely placed in a field.

### BRIEF SUMMARY

In some embodiments, an implement for working an agricultural field includes a frame and a plurality of row units carried by the frame. Each row unit includes a subframe trailing the frame and connected to the frame by an upper link and a lower link, at least two different ground-engaging tools carried by the subframe, and at least one pneumatic actuator configured to change a length of the upper link or the lower link to keep the ground-engaging tools in contact with ground.

A method of working an agricultural field includes pulling an implement through the agricultural field, maintaining a selected pressure in the pneumatic actuator, and maintaining the ground-engaging tools in contact with the agricultural field.

### BRIEF DESCRIPTION OF THE DRAWINGS

While the specification concludes with claims particularly pointing out and distinctly claiming what are regarded as embodiments of the present disclosure, various features and advantages of embodiments of the disclosure may be more readily ascertained from the following description of example embodiments when read in conjunction with the accompanying drawings, in which:

FIG. 1 is a simplified top view of a tractor drawing an agricultural implement through a field;

FIG. 2 is a simplified side view of the implement and illustrating a row unit carried by the implement;

FIG. 3 is a simplified side view of the implement shown in FIG. 2 encountering a drop in field elevation;

FIG. 4 is a simplified side view of the implement shown in FIG. 2 encountering a trench or gully; and

FIG. 5 is a simplified flow chart illustrating a method of working an agricultural field.

### DETAILED DESCRIPTION

The illustrations presented herein are not actual views of any machine, sensor, or portion thereof, but are merely idealized representations that are employed to describe example embodiments of the present disclosure. Additionally, elements common between figures may retain the same numerical designation.

The following description provides specific details of embodiments of the present disclosure in order to provide a thorough description thereof. However, a person of ordinary skill in the art will understand that the embodiments of the disclosure may be practiced without employing many such specific details. Indeed, the embodiments of the disclosure may be practiced in conjunction with conventional techniques employed in the industry. In addition, the description provided below does not include all elements to form a complete structure or assembly. Only those process acts and structures necessary to understand the embodiments of the disclosure are described in detail below. Additional conventional acts and structures may be used. The drawings accompanying the application are for illustrative purposes only, and are thus not drawn to scale.

As used herein, the terms “comprising,” “including,” “containing,” “characterized by,” and grammatical equivalents thereof are inclusive or open-ended terms that do not exclude additional, unrecited elements or method steps, but also include the more restrictive terms “consisting of” and “consisting essentially of” and grammatical equivalents thereof.

As used herein, the term “may” with respect to a material, structure, feature, or method act indicates that such is contemplated for use in implementation of an embodiment of the disclosure, and such term is used in preference to the more restrictive term “is” so as to avoid any implication that other, compatible materials, structures, features, and methods usable in combination therewith should or must be excluded.

As used herein, the term “configured” refers to a size, shape, material composition, and arrangement of one or more of at least one structure and at least one apparatus facilitating operation of one or more of the structure and the apparatus in a predetermined way.

As used herein, the singular forms following “a,” “an,” and “the” are intended to include the plural forms as well, unless the context clearly indicates otherwise.

As used herein, the term “and/or” includes any and all combinations of one or more of the associated listed items.

As used herein, spatially relative terms, such as “beneath,” “below,” “lower,” “bottom,” “above,” “upper,” “top,” “front,” “rear,” “left,” “right,” and the like, may be used for ease of description to describe one element's or feature's relationship to another element(s) or feature(s) as illustrated in the figures. Unless otherwise specified, the spatially relative terms are intended to encompass different orientations of the materials in addition to the orientation depicted in the figures.

As used herein, the term “substantially” in reference to a given parameter, property, or condition means and includes to a degree that one of ordinary skill in the art would understand that the given parameter, property, or condition is met with a degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter).

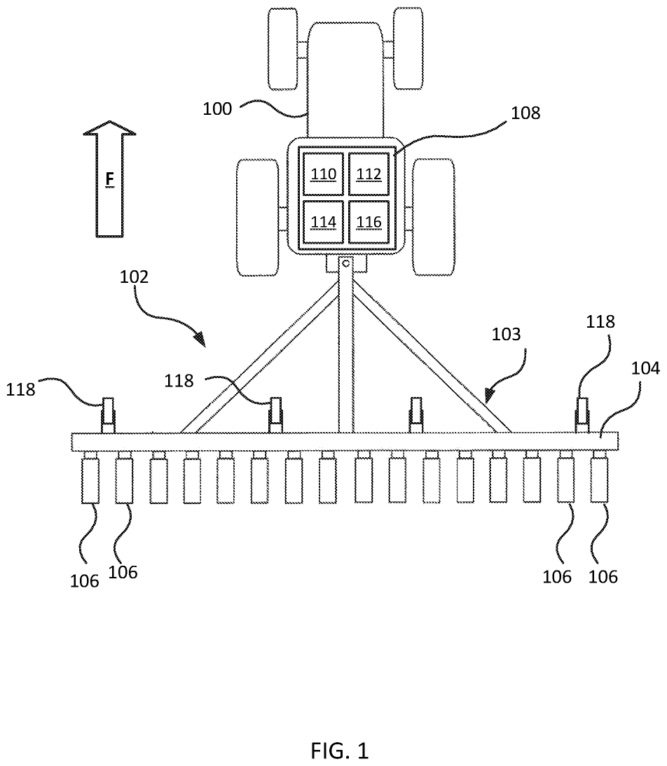

FIG. 1 illustrates a tractor 100 drawing an agricultural implement 102, which has a frame 103 including a toolbar 104 supporting row units 106. A computer 108, which may include a central processing unit (“CPU”) 110, memory 112, implement controller 114, and graphical user interface (“GUI”) (e.g., a touch-screen interface), is typically located in the cab of the tractor 100. A global positioning system (“GPS”) receiver 116 may be mounted to the tractor 100 and connected to communicate with the computer 108. The computer 108 may include an implement controller 114 configured to communicate with the row units 106 and/or the GPS receiver 116, such as by wired or wireless communication. The implement 102 may be supported in the field by at least one wheel 118 coupled to the toolbar 104. Typically, the toolbar 104 is attached to at least two wheels 118, such as to four wheels as shown in FIG. 1. In other embodiments, the wheels 118 may be omitted.

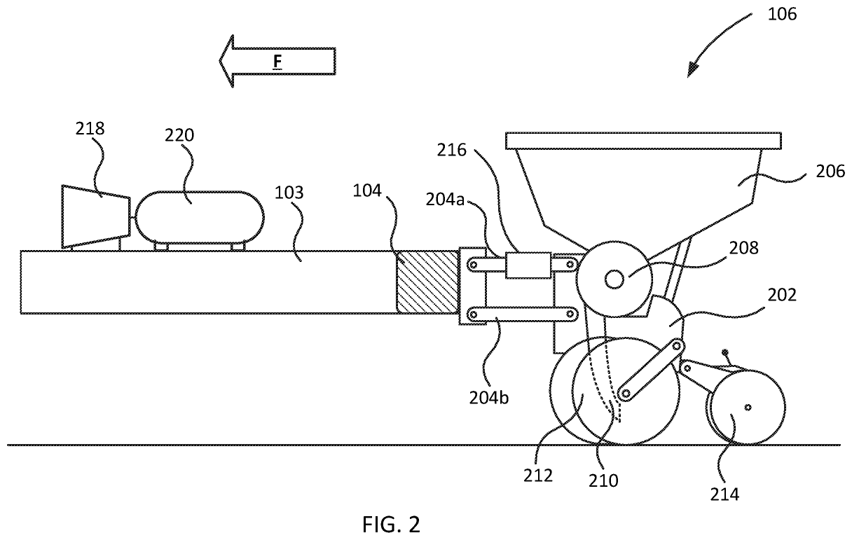

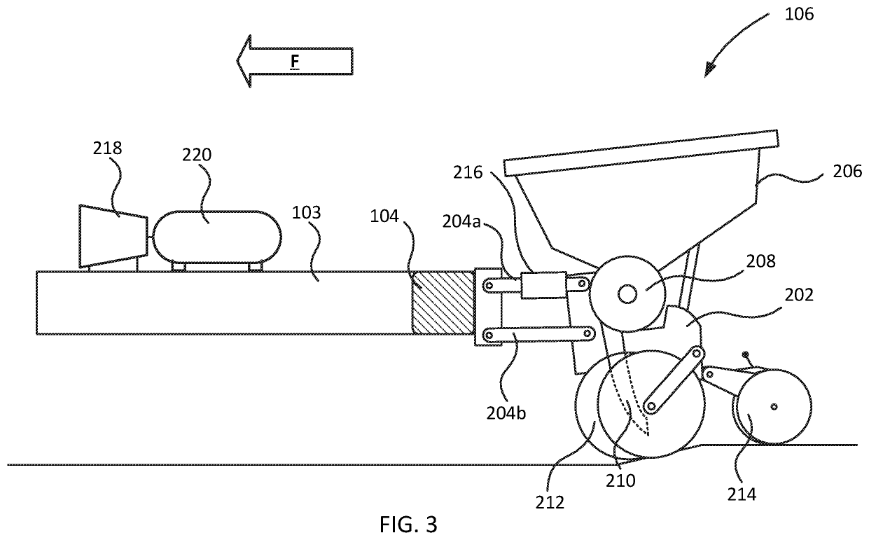

The row units 106 may be any type of ground-engaging device for planting, seeding, fertilizing, tilling, or otherwise working crops or soil, typically in rows. As an example, FIG. 2 is a simplified side view of the implement 102 and illustrates a row unit 106 in the form of a planter row unit. The row unit 106 includes a subframe 202 trailing the frame 103 of the implement 102 as the implement 102 travels in the forward direction F. The subframe 202 is connected to the toolbar 104 of the frame 103 by a linkage having an upper link 204a and a lower link 204b. Though only one of each link 204a, 204b is shown in the view of FIG. 3, there may typically be two upper links 204a and two lower links 204b, with each upper link 204a oriented parallel to one another and each lower link 204b oriented parallel to one another. That is, one of the upper links 204a and one of the lower links 204b are hidden from view because the view of FIG. 2 is from the side of the implement 102. In other embodiments, the upper link 204a may be a single unitary member that connects to both sides of the subframe 202 or otherwise in a manner to provide lateral rigidity. For example, the upper link 204a may be connected to the subframe 202 and the toolbar 104 by pin connections that enable the upper link 204a to rotate in a plane. Likewise, the lower link 204b may be a single unitary member that connects to both sides of the subframe 202.

The links 204 are shown connected to the toolbar 104 and the subframe 202 such that the links 204a, 204b are parallel to one another, but the upper link(s) 204a need not be parallel to the lower link(s) 204b.

The subframe 202 may be a unitary member, or may include one or more members coupled together (e.g., by bolts, welds, etc.). The subframe 202 carries at least two different ground-engaging tools. For example, the ground-engaging tools may include a seed trench opening assembly 212 and a trench closing assembly 214. The subframe 202 may also support one or more hoppers 206, a seed meter 208, a seed delivery mechanism 210, and any other components as known in the art. It should be understood that the row unit 106 shown in FIG. 2 may optionally be a part of a central fill planter, in which case the hoppers 206 may be one or more mini-hoppers fed by a central hopper carried by the implement 102.

The links 204 enable the subframe 202 to move vertically independent of the toolbar 104. At least one of the links 204 may include a pneumatic actuator 216 configured to change a length of the upper link(s) 204a or the lower link(s) 204b to keep the ground-engaging tools in contact with ground. For example, and as shown in FIG. 2, a portion of the upper link 204a may be the actuator 216, including a piston and plunger. Movement of the plunger within the piston changes the length of the upper link 204a. In the embodiment shown in FIG. 2, the lower link 204b has a fixed length. In some embodiments, the lower link 204b may include the actuator 216. In other embodiments, both the upper link 204a and the lower link 204b may include actuators 216.

Furthermore, whether on the upper link 204a, the lower link 204b, or both, the actuator 216 may include more than one actuator. For example, in embodiments in which there are two parallel upper links 204a or a single unitary upper link 204a, there may be two actuators 216 arranged side-by-side as part of the upper link(s) 204a. In some embodiments, the two actuators 216 may be single-action actuators, with one configured to push when pressure is applied, and the other configured to pull when pressure is applied. In other embodiments, the actuator(s) 216 may be dual-action actuators. In still other embodiments, the actuators 216 may be single-action actuators configured to only push the row units 106 downward. In general, the actuators 216 may tilt the row units 106 forward for headland operations or transport (i.e., to assist in raising the ground-engaging tools off the ground), and tilt the row units 106 rearward for field operations. Field operations are discussed in more detail below.

As the implement 102 travels across an agricultural field, the row units 106 may encounter changes in terrain, rocks, or other obstacles. The actuator(s) 216 may adjust the angle of the subframe 202 relative to the toolbar 104 such that the ground-engaging tools remain in contact with the ground.

For example, FIG. 3 illustrates a portion of the implement 102 passing a drop in the elevation of the field. The frame 103 and toolbar 104 (as well as the tractor 100 pulling the implement 102) have passed to lower ground, but the row unit 106 is still partially engaged with the higher ground. The actuator 216 may change the length of the upper link(s) 204a to allow the subframe 202 of the row unit 106 to tilt or rotate relative to the toolbar 104. Thus, as illustrated, the subframe 202 may tilt forward to keep the seed trench opening assembly 212 in contact with the ground when the implement 102 travels to lower ground. Likewise, the subframe 202 may tilt rearward to keep the trench closing assembly 214 in contact with the ground when the implement 102 travels to higher ground.

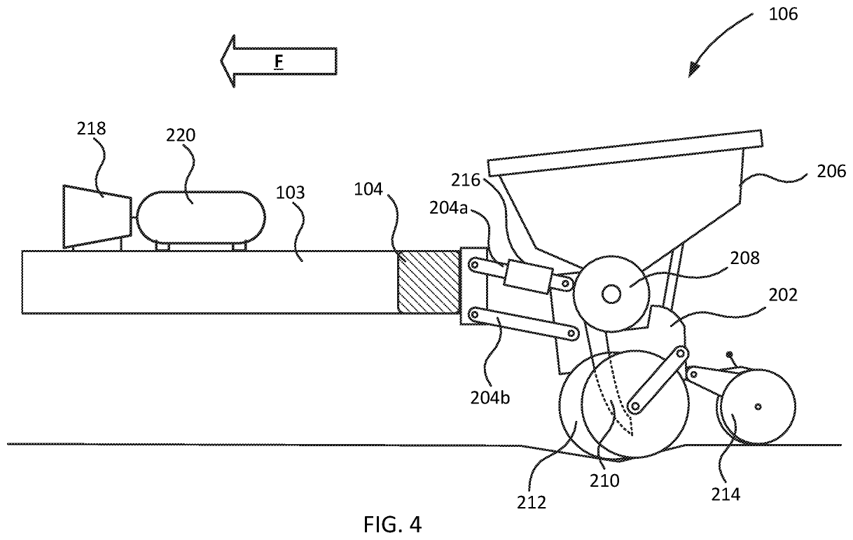

FIG. 4 illustrates a portion of the implement 102 passing a trench, gully, or other temporary drop in the level of the field. The frame 103 and toolbar 104 (as well as the tractor 100 pulling the implement 102) have passed the drop, but the row unit 106 is just coming upon the drop. The actuator 216 may shorten the upper link(s) 204a to tilt the subframe 202 forward as the seed trench opening assembly 212 enters to the trench to keep the seed trench opening assembly 212 in contact with the ground in the trench. Likewise, the subframe 202 may tilt rearward as the trench closing assembly 214 enters the trench to keep the trench closing assembly 214 in contact with the ground in the trench.

The actuator(s) 216 may operate in a similar manner when encountering a rise in the ground, a rock, a ridge, or other terrain or obstruction. Thus the actuator(s) 216 may assist in keeping multiple ground-engaging tools in contact with the ground by changing the orientation of the subframe 202 relative to the toolbar 104.

The actuator(s) 216 may be selected to be pneumatic, i.e., to operate based on compressed air. The implement 102 may carry a pneumatic source, such as a compressor 218 and/or a pressure tank 220, in fluid communication with the actuator(s) 216 (fluid lines are omitted from FIGS. 2-4 for clarity). The compressor 218 and/or pressure tank 220 may maintain the actuator(s) 216 at a preselected pressure. When, for example, a row unit 106 encounters a change in terrain that changes the amount of force on the front or rear ground-engaging tool (i.e., the seed trench opening assembly 212 or the trench closing assembly 214, respectively, in the example of FIGS. 2-4), the air pressure within the actuator(s) 216 may tend to change due to a change in volume of the actuator(s) 216. The compressor 218 and/or pressure tank 220 can compensate quickly because the compressed air can flow freely to or from the actuator(s) 216 to equalize pressure in the system. The actuator(s) 216 may all be connected to the same compressor 218 and/or pressure tank 220.

An advantage of pneumatic actuators 216 over actuators driven by hydraulic fluid is that, because air can be compressed, pneumatic actuators 216 can respond more quickly than other types of actuators. Thus, pneumatic actuators 216 can adapt to changes in terrain or obstructions to keep the ground-engaging tools in contact with the ground, even without prior knowledge of the ground contours and obstacles (e.g., a field map, information from sensors leading the row units, etc.).

Furthermore, because each row unit 106 may have separate actuator(s) 216, each row unit 106 can respond to the terrain or obstacles affecting that row unit 106. Thus, adjacent row units, encountering different terrain changes or obstacles, can still both keep their seed trench opening assemblies 212 and trench closing assemblies 214 in contact with the ground.

Another advantage is that the down pressure on the trench closing assemblies 214 can be changed from the cab of the tractor 100, such as by changing a setting on the computer 108. The computer 108 may then control the pressure in the compressor 218 and/or pressure tank 220 to cause a selected down pressure.

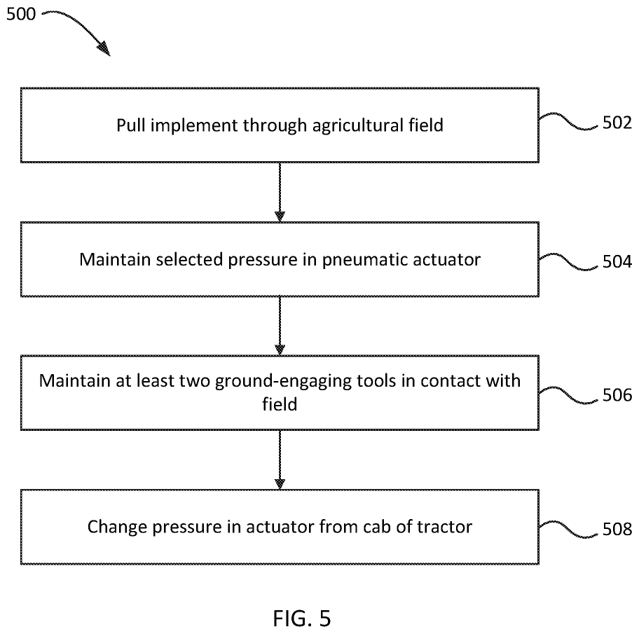

FIG. 5 is a simplified flow chart illustrating a method 500 of working an agricultural field. Block 502 represents pulling an implement through an agricultural field, such as the implement 102 shown and described above. Block 504 represents maintaining a selected pressure in a pneumatic actuator that is configured to change a length of an upper link or lower link of a row unit. The pressure may be maintained within a pressure tank connected to the pneumatic actuator.

In block 506, at least two ground-engaging tools are maintained in contact with the field, even when the implement traverses changes in terrain. The tools may each be maintained at a constant preselected down pressure. In block 508, the pressure in the pneumatic actuator is changed from the cab of a tractor pulling the implement. For example, the pressure may be changed while the implement is moving in the field.

Additional non-limiting example embodiments of the disclosure are described below.

Embodiment 1: An implement for working an agricultural field, the implement comprising a frame and a plurality of row units carried by the frame. Each row unit comprises a subframe trailing the frame and connected to the frame by an upper link and a lower link, at least two different ground-engaging tools carried by the subframe, and at least one pneumatic actuator configured to change a length of the upper link or the lower link to keep the at least two different ground-engaging tools in contact with ground.

Embodiment 2: The implement of Embodiment 1, wherein the at least one pneumatic actuator comprises a pair of pneumatic actuators.

Embodiment 3: The implement of Embodiment 2, wherein the pair of pneumatic actuators are oriented parallel to one another.

Embodiment 4: The implement of Embodiment 2 or Embodiment 3, wherein the pair of pneumatic actuators are connected to a common pneumatic source.

Embodiment 5: The implement of any one of Embodiment 1 through Embodiment 4, wherein the upper link comprises the at least one pneumatic actuator.

Embodiment 6: The implement of any one of Embodiment 1 through Embodiment 4, wherein the lower link comprises the at least one pneumatic actuator.

Embodiment 7: The implement of any one of Embodiment 1 through Embodiment 6, wherein the upper link or the lower link has a fixed length.

Embodiment 8: The implement of any one of Embodiment 1 through Embodiment 7, wherein the upper link is parallel to the lower link.

Embodiment 9: The implement of any one of Embodiment 1 through Embodiment 8, wherein the at least two different ground-engaging tools comprise an opener blade and a closing wheel.

Embodiment 10: The implement of any one of Embodiment 1 through Embodiment 9, wherein one of the at least two different ground-engaging tools trails another of the at least two different ground-engaging tools when the implement travels in the agricultural field.

Embodiment 11: The implement of any one of Embodiment 1 through Embodiment 10, further comprising a compressor carried by the frame and in fluid communication with the at least one pneumatic actuator.

Embodiment 12: The implement of any one of Embodiment 1 through Embodiment 11, further comprising a pressure tank carried by the frame and in fluid communication with the at least one pneumatic actuator.

Embodiment 13: The implement of any one of Embodiment 1 through Embodiment 12, wherein the at least one pneumatic actuator comprises at least one dual-action actuator.

Embodiment 14: The implement of any one of Embodiment 1 through Embodiment 12, wherein the at least one pneumatic actuator comprises at least two single-action actuators.

Embodiment 15: A method of working an agricultural field, the method comprising pulling an implement through the agricultural field. The implement comprises a frame carrying a plurality of row units. Each row unit comprises a subframe trailing the frame and connected to the frame by an upper link and a lower link, at least two different ground-engaging tools carried by the subframe, and at least one pneumatic actuator configured to change a length of the upper link or the lower link. The method further comprises maintaining a selected pressure in the at least one pneumatic actuator and maintaining the at least two ground-engaging tools in contact with the agricultural field.

Embodiment 16: The method of Embodiment 15, wherein maintaining a selected pressure in the at least one pneumatic actuator comprises maintaining the selected pressure in a pressure tank carried by the frame and in fluid communication with the at least one pneumatic actuator.

Embodiment 17: The method of Embodiment 15 or Embodiment 16, wherein maintaining the at least two ground-engaging tools in contact with the agricultural field comprises maintaining the at least two ground-engaging tools in contact with the agricultural field over changes in terrain.

Embodiment 18: The method of any one of Embodiment 15 through Embodiment 17, wherein maintaining the at least two ground-engaging tools in contact with the agricultural field comprises maintaining a constant down pressure on each of the at least two ground-engaging tools.

Embodiment 19: The method of any one of Embodiment 15 through Embodiment 18, wherein maintaining the at least two ground-engaging tools in contact with the agricultural field comprises applying equivalent down pressures to each of the at least two ground-engaging tools.

Embodiment 20: The method of any one of Embodiment 15 through Embodiment 19, further comprising changing the selected pressure in the at least one pneumatic actuator from a cab of a tractor pulling the implement.

All references cited herein are incorporated herein in their entireties. If there is a conflict between definitions herein and in an incorporated reference, the definition herein shall control.

While the present disclosure has been described herein with respect to certain illustrated embodiments, those of ordinary skill in the art will recognize and appreciate that it is not so limited. Rather, many additions, deletions, and modifications to the illustrated embodiments may be made without departing from the scope of the invention as hereinafter claimed, including legal equivalents thereof In addition, features from one embodiment may be combined with features of another embodiment while still being encompassed within the scope of the invention as contemplated by the inventors. Further, embodiments of the disclosure have utility with different and various agricultural machine types and configurations.

1. An implement for working an agricultural field, the implement comprising:
a frame; and
a plurality of row units carried by the frame, each row unit comprising:
a subframe trailing the frame and connected to the frame by an upper link and a lower link parallel to the upper link, wherein the upper link is connected to the frame at a first pivot and to the subframe at a second pivot, and the lower link is connected to the frame at a third pivot and to the subframe at a fourth pivot;
at least two different ground-engaging tools carried by the subframe; and
at least one pneumatic actuator configured to change a length of the upper link or the lower link to keep the at least two different ground-engaging tools in contact with ground.

2. The implement of claim 1, wherein the at least one pneumatic actuator comprises a pair of pneumatic actuators.

3. The implement of claim 2, wherein the pair of pneumatic actuators are oriented parallel to one another.

4. The implement of claim 2, wherein the pair of pneumatic actuators are connected to a common pneumatic source.

5. The implement of claim 1, wherein the upper link comprises the at least one pneumatic actuator.

6. The implement of claim 1, wherein the lower link comprises the at least one pneumatic actuator.

7. thee implement of claim 1, wherein the upper link or the lower link has a fixed length.

8. The implement of claim 1, wherein the upper link is parallel to the lower link.

9. The implement of claim 1, wherein the at least two different ground-engaging tools comprise an opener blade and a closing wheel.

10. The implement of claim 1, wherein one of the at least two different ground-engaging tools trails another of the at least two different ground-engaging tools when the implement travels in the agricultural field.

11. The implement of claim 1, further comprising a compressor carried by the frame and in fluid communication with the at least one pneumatic actuator.

12. The implement of claim 1, further comprising a pressure tank carried by the frame and in fluid communication with the at least one pneumatic actuator.

13. The implement of claim 1, wherein the at least one pneumatic actuator comprises at least one dual-action actuator.

14. The implement of claim 1, wherein the at least one pneumatic actuator comprises at least two single-action actuators.

15. A method of working an agricultural field, the method comprising:
pulling an implement through the agricultural field, the implement comprising:
a frame carrying a plurality of row units, each row unit comprising:
a subframe trailing the frame and connected to the frame by an upper link and a lower link parallel to the upper link, wherein the upper link is connected to the frame at a first pivot and to the subframe at a second pivot, and the lower link is connected to the frame at a third pivot and to the subframe at a fourth pivot;
at least two different ground-engaging tools carried by the subframe; and
at least one pneumatic actuator configured to change a length of the upper link or the lower link;
maintaining a selected pressure in the at least one pneumatic actuator; and
maintaining the at least two ground-engaging tools in contact with the agricultural field.

16. The method of claim 15, wherein maintaining a selected pressure in the at least one pneumatic actuator comprises maintaining the selected pressure in a pressure tank carried by the frame and in fluid communication with the at least one pneumatic actuator.

17. The method of claim 15, wherein maintaining the at least two ground-engaging tools in contact with the agricultural field comprises maintaining the at least two ground-engaging tools in contact with the agricultural field over changes in terrain.

18. The method of claim 15, wherein maintaining the at least two ground-engaging tools in contact with the agricultural field comprises maintaining a constant down pressure on each of the at least two ground-engaging tools.

19. The method of claim 15, wherein maintaining the at least two ground-engaging tools in contact with the agricultural field comprises applying equivalent down pressures to each of the at least two ground-engaging tools.

20. The method of claim 15, further comprising changing the selected pressure in the at least one pneumatic actuator from a cab of a tractor pulling the implement.
